(19) United States
(12) Patent Application Publication
(10) Pub. No.: US 2001/0030448 A1
(43) Pub. Date: Oct. 18, 2001

(54) Sport utility truck with back door at rear of passenger compartment

(76) Inventor: Doug G. Wilson, Carlsbad, CA (US)

Correspondence Address: FOLEY & LARDNER, Washington Harbour, Suite 500, 3000 K Street, N.W., Washington, DC, 20007-5109, US

(21) Appl. No.: 09/741,850

(22) Filed: Dec. 22, 2000

Related U.S. Application Data
(60) Provisional application No. 60/173,511, filed on Dec. 29, 1999.

(51) Int. Cl. B62D 33/06; B60J 5/00

(52) U.S. Cl. 296/190.11; 296/183

(57) ABSTRACT

A vehicle has a cab with a front seat and a rear seat; a cargo area behind the cab; and a back door between the cab and the cargo area. At least one hinge connects the back door to the cab such that the back door opens outward and upward.

The benefit of priority of U.S. Provisional Application No. 60/173,511, filed Dec. 29, 1999 is hereby claimed. The entire contents of this Provisional Application are incorporated herein by reference.

The invention relates to trucks, such as sport utility trucks (SUTs). More specifically, the invention is directed to a new type of SUT which includes a back door at the rear of the passenger compartment.

### SUMMARY OF THE INVENTION

An object of the invention is to provide an improved vehicle. Another object of the invention is to provide a more flexible arrangement for a vehicle, such as an SUT.

According to one aspect of the invention, there is provided a vehicle having a cab with a front seat and a rear seat; an outside cargo bed behind the cab; and a back door between the cab and the cargo bed. At least one hinge connects the back door to the cab such that the back door opens outward and upward.

According to another aspect of the invention, the invention provides the ornamental design for a vehicle as shown and described.

### BRIEF DESCRIPTION OF THE DRAWINGS

FIG. 1 shows an SUT having a back door, with the back door being in a closed position;

FIG. 2 shows an SUT having a back door, with the back door being in the open position;

FIGS. 3 and 4 show a cab and a cargo bed of an SUT, with a back door closed and opened, respectively;

FIG. 5 is a perspective view of the vehicle of FIG. 4; and

FIGS. 6 to 11 are views illustrating vehicles which embody the invention.

### DETAILED DESCRIPTION OF PREFERRED EMBODIMENTS

Current commercially-available pick-up type trucks do not have a back door between the passenger compartment (or cab) and the cargo area (or bed).

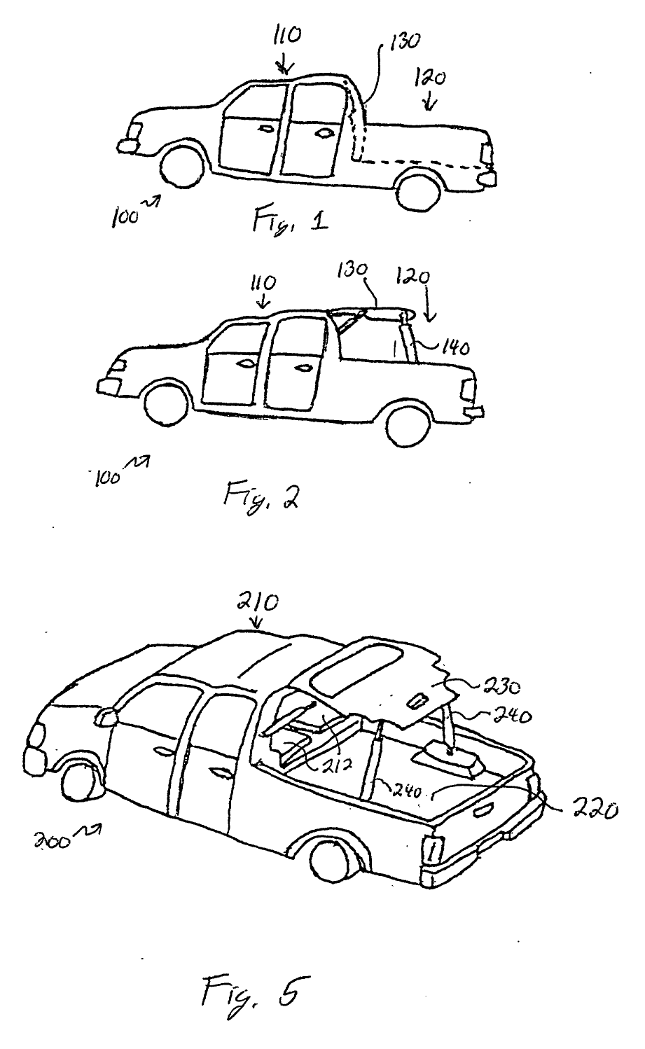

In the present invention, a truck is provided with a rear seat and a back door, such that the truck can accommodate longer objects when the back door is open and the rear seat is stowed out of the way. Such a design is shown in FIGS. 1 and 2. FIG. 1 shows a SUT 100, with a cab 110, a cargo bed 120, and a back door 130. FIG. 2 shows SUT 100 with the back door 130 held open by a stay(s) 140. A similar design is shown in the International Automobile Manufacturers Update, Vol. 10, No. 8 (August 1999), the entire contents of which are incorporated herein by reference.

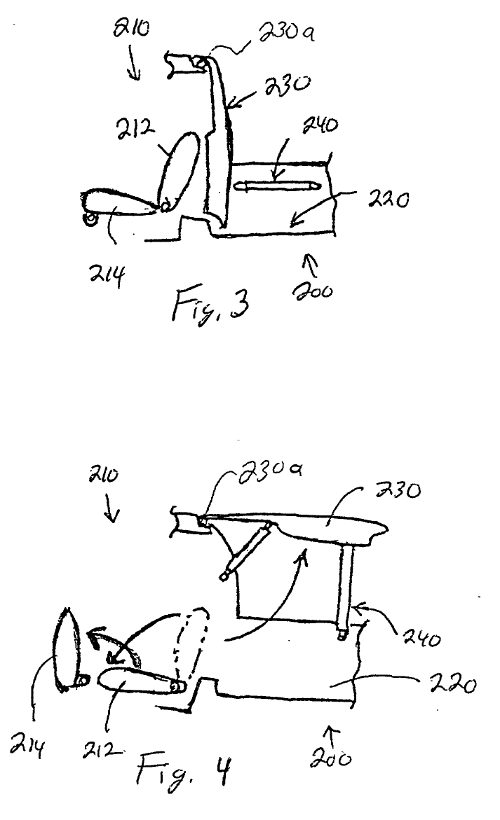

FIGS. 3 and 4 show a portion of a cab 210 and cargo bed 220 for a vehicle 200. FIG. 3 shows cab 210 having a rear seat bottom 214 and a rear seat back 212 in a seating position. In FIG. 3, a back door 230 is in the closed position and a back door stay(s) 240 is in the stowed position. FIG. 4 shows the same vehicle with the back door 230 open and supported by stay(s) 240. The stay(s) 240 can support the back door when the vehicle is running. In this design, the back door is connected to the roof of the cab by hinges 230a, and the back door occupies most of the rear face of the cab. In FIG. 4, the rear seat bottom and the rear seat back are in a non-seating position. When the back door is opened, the rear seat bottom 214 can be in a pushed forward position and the rear seat back can be in a pushed down position so that it lies flat. Such an arrangement allows the space normally occupied by the rear seat to be used as cargo space (as an extension of the cargo bed). FIG. 5 shows an overall perspective view of this arrangement.

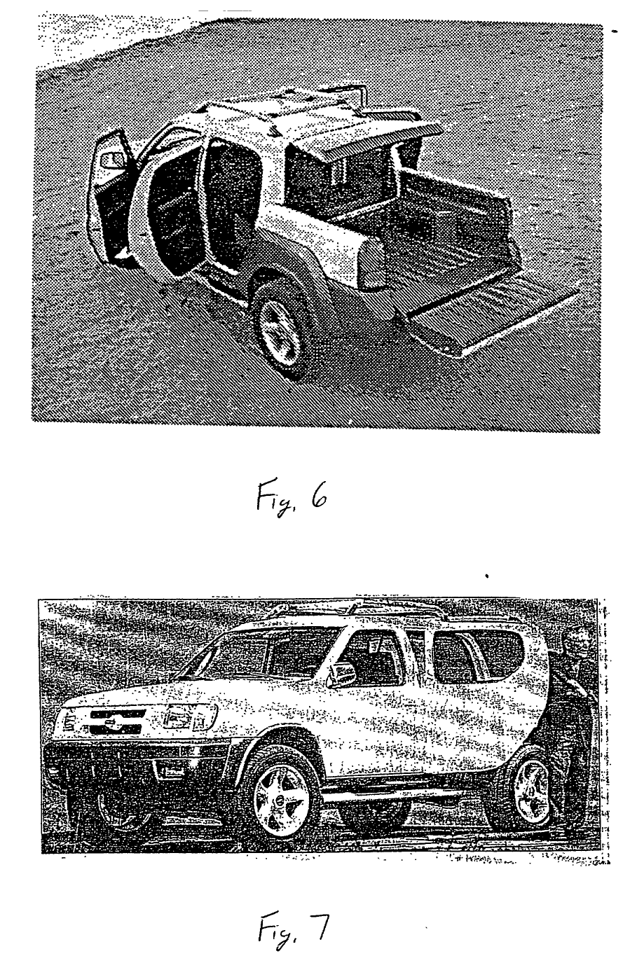

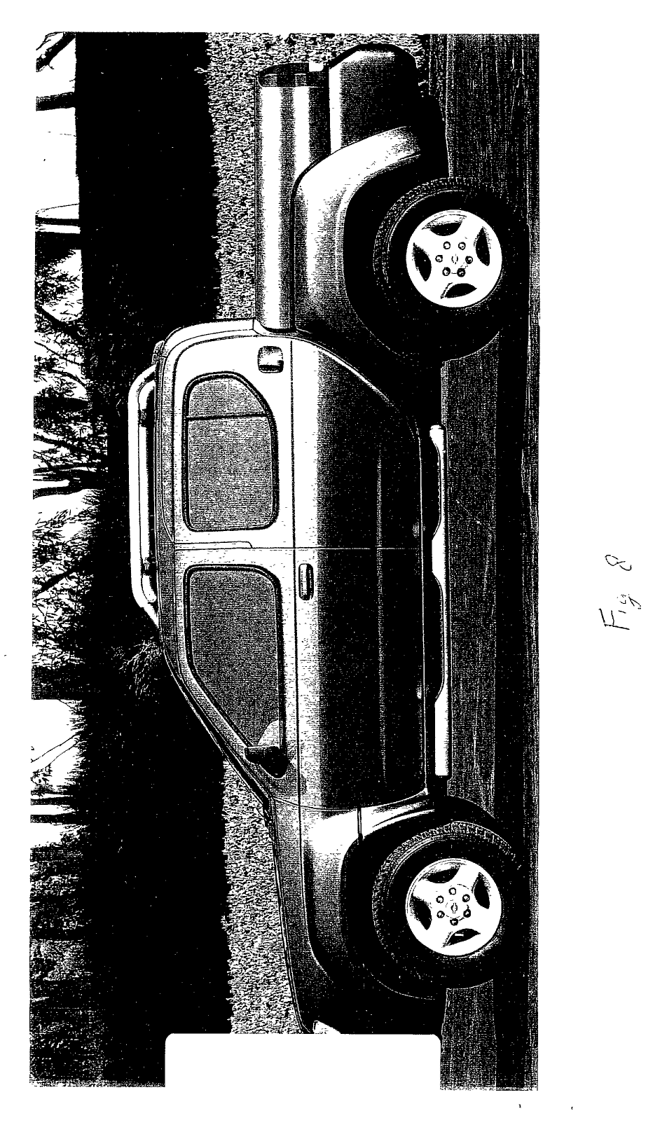

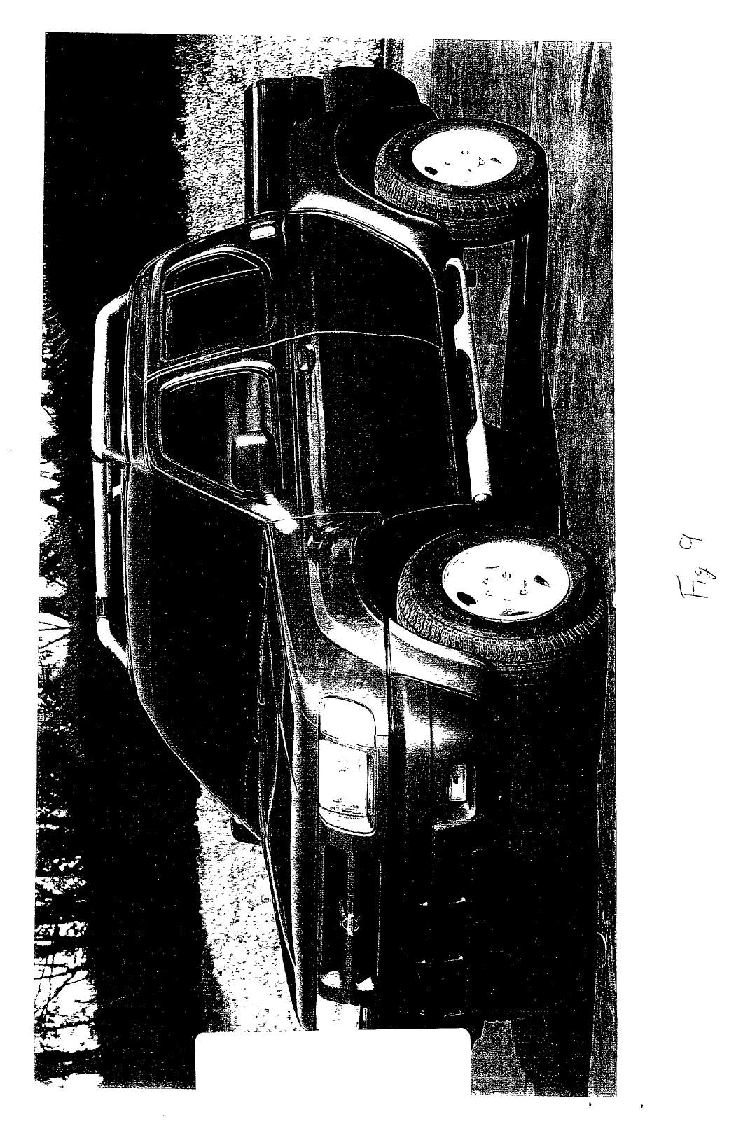

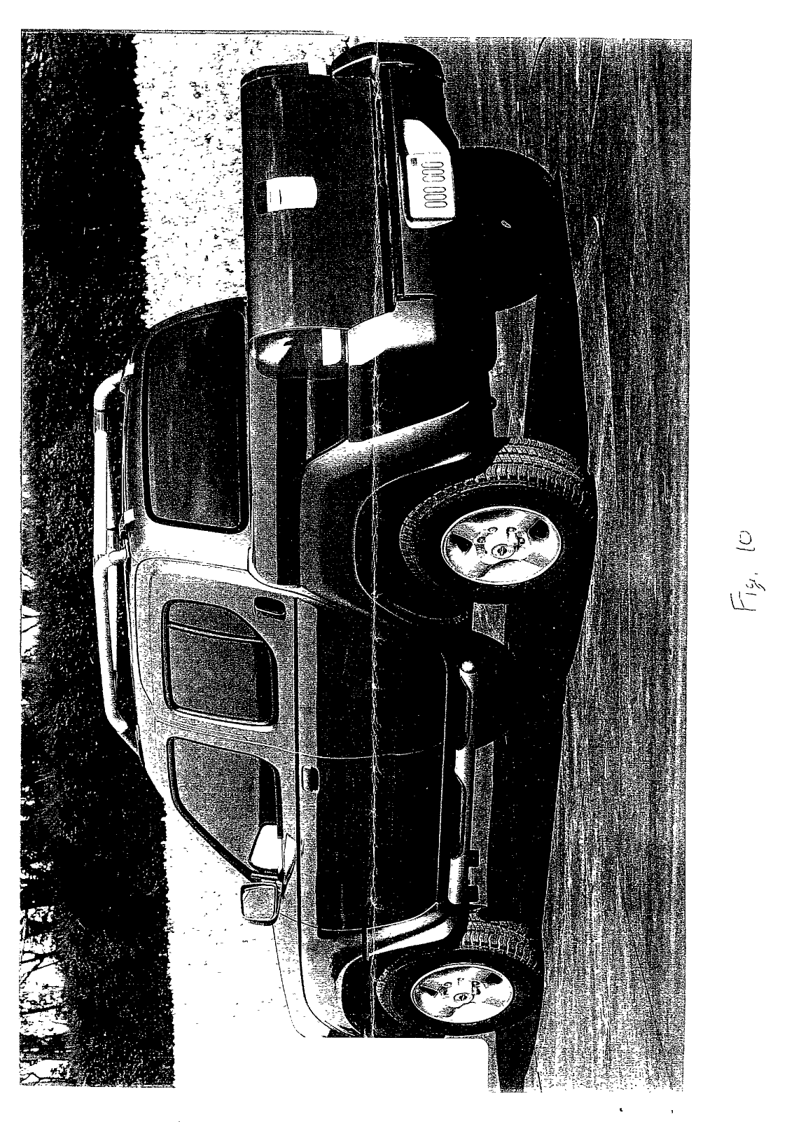

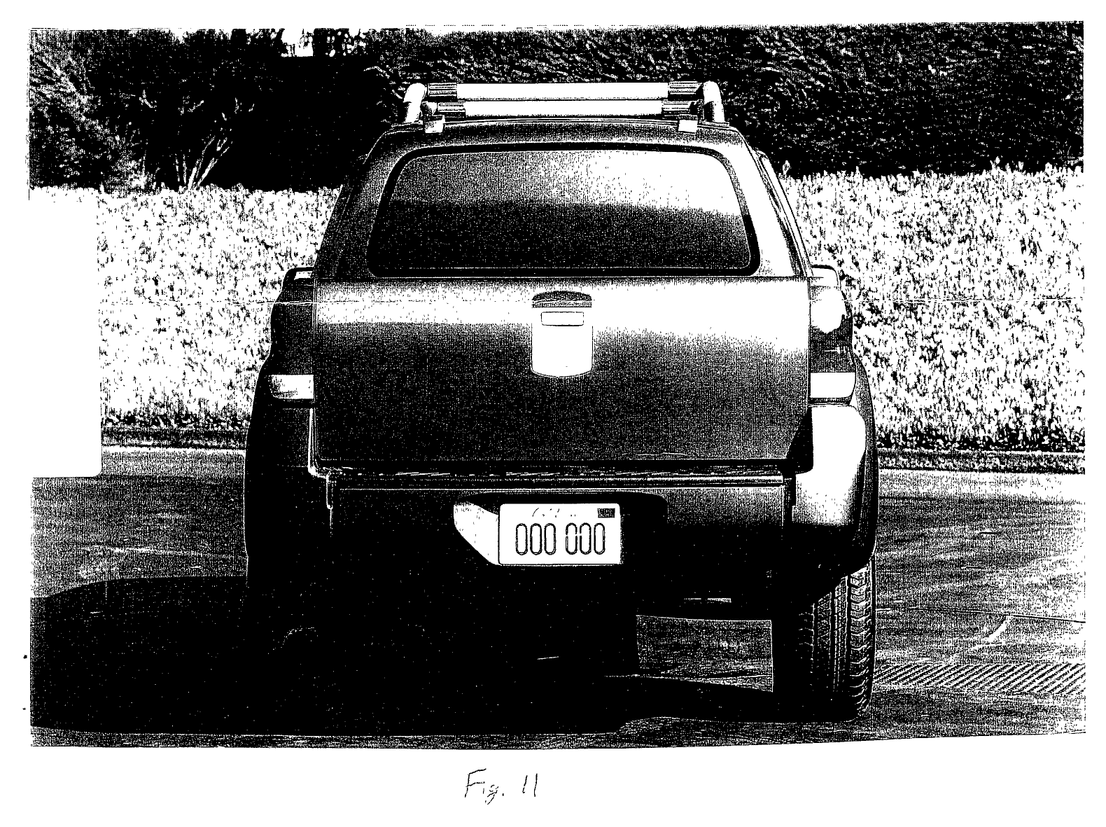

FIGS. 6 to 11 are views illustrating vehicles which embody the invention. FIG. 8 depicts the left side of a vehicle. The right side is similar to the left side. The license plate, the Nissan insignia, and the coloring shown in these figures do not constitute an integral part of the disclosed and claimed design/invention.

As can be appreciated from these figures, the present invention provides both sedan seating and pick-up truck utility. In the present invention, when the rear seat back is folded out of the way, an extension of the cargo bed is formed.

The invention may be used in conjunction with the interlocks described in U.S. patent application Ser. No. 09/525,053, filed Mar. 14, 2000, and entitled “Sport Utility Truck Interlocks.” The entire contents of this application are incorporated herein by reference.

The invention is not limited to the specific examples of the invention set forth above. Variations and modifications of the examples set forth above will occur to those in the field. For example, the back door stays can be provided at other locations than set forth above, or the stays 140 and 240 can be deleted and the back door can be supported entirely by a stay(s) between the rear pillar of the cab and the back door. Such variations and modifications are within the spirit and scope of the invention. Accordingly, the invention is defined with reference to the following claims.

What is claimed is:

1. A vehicle, comprising:
a cab having a front seat and a rear seat;
a cargo bed behind the cab;
a back door between the cab and the cargo bed; and
at least one hinge to connect the back door to the cab such that the back door opens outward and upward.

2. A vehicle as set forth in claim 1, wherein the back door occupies most of a rear face of the cab.

3. A vehicle as set forth in claim 1, wherein the back door includes a window.

4. A vehicle as set forth in claim 2, wherein the back door includes a window.

5. A vehicle as set forth in claim 1, wherein when the rear seat is in a non-seating position and the back door is opened, an extension of the cargo bed is formed.

6. A vehicle as set forth in claim 1, further comprising at least one stay to hold open the back door.

7. A vehicle as set forth in claim 1, wherein the rear seat comprises a rear seat bottom and a rear seat back, and wherein when the back door is opened, the rear seat bottom can be positioned in a pushed forward position and the rear seat back can be positioned in a pushed down position so that the rear seat back lies flat.

8. A vehicle as set forth in claim 1, further comprising a rear side door of the cab and wherein a rear edge of the rear side door and an outer edge of the back door are adjacent to each other when the re ar door and the back door are both closed.

9. A vehicle, comprising:
a cab having a front seat and a rear seat;
a cargo bed behind the cab;
a hinged back door between the cab and the cargo bed; and
wherein the rear seat includes a rear seat bottom and a rear seat back, and wherein the rear seat bottom can be positioned in a pushed forward position and the rear seat back can be positioned in a pushed down position so that an extension of the cargo bed is formed when the back door is opened.
